(19) United States
(12) Patent Application Publication
(10) Pub. No.: US 2007/0176745 A1
(43) Pub. Date: Aug. 2, 2007

(54) Telecom Equipment With RFIDs

(75) Inventors: Jeff Gibson, Spokane, WA (US); Lloyd Lohf, Liberty Lake, WA (US)

Correspondence Address: LEE & HAYES, PLLC, 421 W. RIVERSIDE AVE, STE 500, SPOKANE, WA, 99201, US

(73) Assignee: Telect, Inc., Liberty Lake, WA (US)

(21) Appl. No.: 11/275,815

(22) Filed: Jan. 30, 2006

(51) Int. Cl. H04Q 5/22

(52) U.S. Cl. 340/10.1

(57) ABSTRACT

Embodiments of telecommunications equipment with RFID tags are presented herein.

### BACKGROUND

The prevalence of cable and fiber is ever increasing as consumers desire ever increasing amounts of bandwidth to receive content (e.g., network data) and communicate, e.g., via a telephone. One aspect of cable management and maintenance of a cable system is managing information regarding the numerous devices, network elements and equipment used in a telecommunications infrastructure. Traditionally designations of the interconnections of various equipment (e.g., which equipment is interrelated with which other equipment) within a telecommunication network have been maintained on printed grids or labels provided with a piece of telecom equipment. Theses grids or labels are generally hand written. Typically, a technician setting up or maintaining a network refers to a grid for each component or cabinet. Further, infrastructure information such as the type of equipment, type of connections, operating instruction and so on traditionally is maintained separately from the equipment itself, or is not recorded at all.

Thus, traditional records of equipment interconnections and information may be difficult and inconvenient to use. Additionally, maintaining the information for an entire site in a telecommunications network infrastructure, such as a central office, may involve tedious updating of written labels at each of the individual cabinets, panels, components and so forth. Accordingly, the time and costs associated with operating and maintaining a telecommunication infrastructure may be increased.

### SUMMARY

Telecommunications equipment having radio frequency identification (RFID) devices is described. REID tags may be provided on a variety of equipment in telecommunication infrastructure to identify the equipment and to store infrastructure data regarding the equipment and interrelation of equipment.

Each RFID tag has a unique identifier (RFID) which may be utilized to identify equipment. In an implementation REID tags are provided on a plurality of interrelated equipment. For example, a cabinet configured to hold a plurality of components may include an RFID tag associated with the cabinet and RFIDs associated with the components. The plurality of components may be configured to hold a plurality of sub-components which similarly have their own associated RFID tag. Thus, RFID tags may be provided at different levels of equipment in a telecommunication infrastructure, such as for a site, cabinets, component, network element, cabling and combinations thereof.

In an implementation, RFID tags may store a variety of infrastructure data which encompasses data describing the location, configuration, and interconnection of equipment in infrastructure. In this implementation infrastructure data may be obtained directly from RFID tags disposed on equipment throughout the infrastructure.

In another implementation, infrastructure data is maintained in storage which is accessible using RFIDs obtained from RFID tags disposed on equipment in an infrastructure. Storage may be accessible locally from a reader device used to read the RFIDS or remotely via a network.

In one instance, a single REID tag may store a plurality of RFIDs for interrelated equipment. Thus, the single RFID tag may be read to obtain the multiple RFIDs and/or to access information about corresponding equipment.

### BRIEF DESCRIPTION OF THE DRAWINGS

FIG. 1 is an illustration of an environment having a portion of a telecommunications infrastructure.

FIG. 2 is an illustration of an exemplary implementation of a cabinet of FIG. 1 in which RFID tags are provided to identify and/or store information about corresponding equipment.

FIG. 3 is an illustration of accessing RFID tags to obtain RFIDs and/or associated infrastructure data.

FIG. 4 illustrates computer readable infrastructure data.

FIG. 5 is another illustration of computer readable infrastructure data.

FIG. 6 is an illustration of a RFID tag configured to hold infrastructure data in addition to an RFID.

FIG. 7 is a flow diagram depicting a procedure in which an RFID tag is read to identify equipment and/or access data

FIG. 8 is a flow diagram depicting a procedure in which equipment having RFID tags is formed.

### DETAILED DESCRIPTION

It should be noted that the following devices are examples and may be further modified, combined and separated without departing from the spirit and scope thereof.

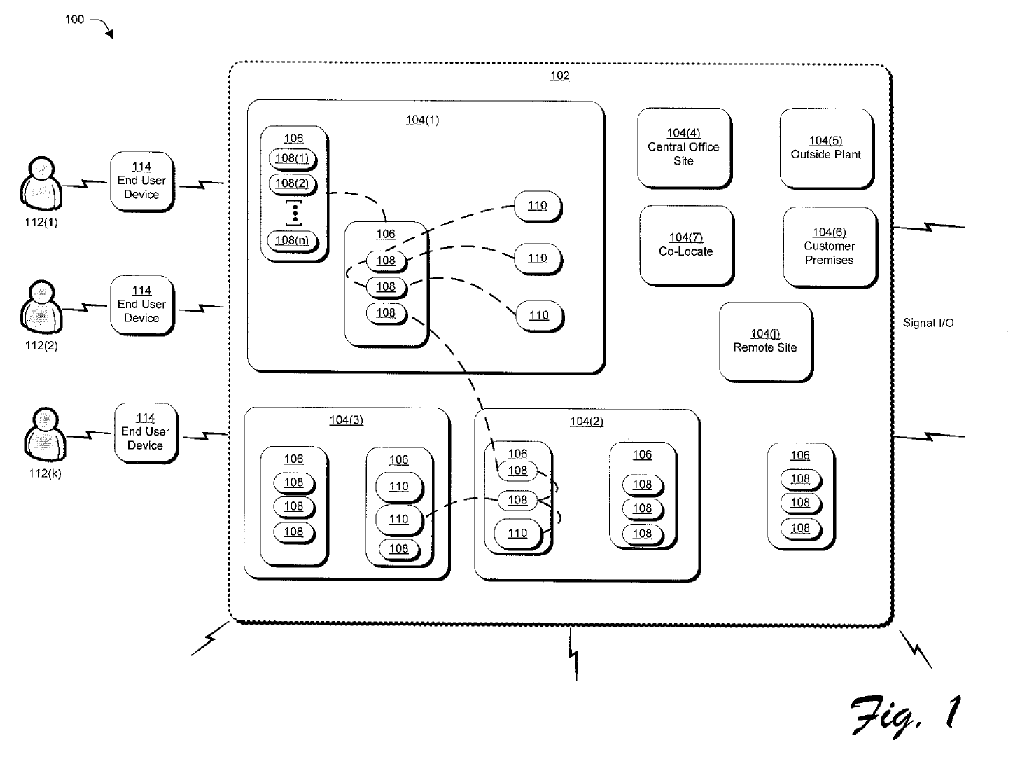

FIG. 1 illustrates an exemplary implementation of an environment 100 operable to provide a telecommunications network in which the apparatuses and procedures of the present disclosure may be employed. The environment 100 includes at least a portion of a telecommunication network infrastructure 102 (hereinafter “infrastructure”). Infrastructure 102 provides telecommunications processes, structures, equipment and devices between end-user devices such as modems, phones, and so on used by end-users outside of the infrastructure 102 to communicate via a telecommunications network. Within infrastructure 102 a variety of equipment, apparatus and devices are utilized in routing, processing, and distributing signals. Telecommunications signals and data may among other actions be processed, switched, routed, tested, patched, managed, or distributed by various equipment in the infrastructure 102.

A variety of sites 104(1)-104(j) within infrastructure 102 may maintain various equipment used in the infrastructure 102, where “j” may be any integer from one to “J”. As depicted in FIG. 1, infrastructure 102 may have numerous sites 104 which may be different physical locations within infrastructure 102 such as a central office, an outside plant site, a co-locate site, a remote site, or customer premises. Sites 104 may be locations within infrastructure 100 which hold a variety of structures and equipment to facilitate processing and distributing of telecommunications signals. The equipment may be centralized in one site (e.g., site 104(1)) or dispersed throughout different sites 104 in infrastructure 102. In other words, interconnections may be made between various sites 104 in infrastructure 102, for example the connection denoted in FIG. 1 by a dashed line between site 104(1) and 104(2). Naturally, numerous interconnections between a plurality of sites 104 typically may be made.

Each site 104 may have one or more housings 106 having a plurality of components 108. A housing refers to a structure to maintain or hold a plurality of components 108 in infrastructure 102 and may be configured in a variety of ways. For example, the housing 106 may be configured as a housing for a cabinet, a terminal block, a panel, a protector block, a chassis, a digital cross-connect, a switch, a hub, a rack, a frame, a bay, a module, an enclosure, an aisle, or other structure for receiving and holding a plurality of components 108. Hereinafter, the terms housing and cabinet will be used for convenience to refer to the variety of structures in infrastructure 102 that may hold components 108. Housings 106 may be inside a building or housings may themselves be configured to be placed outside, e.g. an outside plant cabinet. Housings 106 may typically be configured to protect components 108 from environmental influences. The environment 100 of FIG. 1, for instance, depicts site 104(1) as having two housings (e.g., cabinets) 106, each having a plurality of components 108. Other housings 106 may be included throughout infrastructure 102 at sites 104, for example housings 106 depicted within site 104(2).

Components 108 are pieces of telecommunications equipment in infrastructure 102 that may be kept or maintained in a housing 106 (e.g., a cabinet) within the infrastructure 102. Components for example may be cross-connect panels, modules, terminal blocks, protector blocks, chassis, backplanes, switches, digital radios, repeaters and so forth. Generally, components 108 may be those devices utilized for processing and distributing signals in infrastructure 102 and which may be maintained in a housing 104. Components 108 may also be used to manage cabling in infrastructure 102.

Components 108 may terminate, interconnect or cross-connect a plurality of network elements 110 within infrastructure 102. Components 108 may be utilized to distribute telecommunications signals sent to and from infrastructure 102 by one or more end-users 112 using an end-user device 114. The interconnections between telecommunications equipment (e.g., cabinets 106, components 108 and network elements 110) provide signal pathways for telecommunications signals. Interconnection may be via one or more components 108 such as by connectors disposed on a component, such as a protector block, or may be internal to the components 108 such as via cabling within a component 108. Representative interconnections are shown by dashed lines in FIG. 1 and numerous interconnections within and between telecommunication equipment are typical.

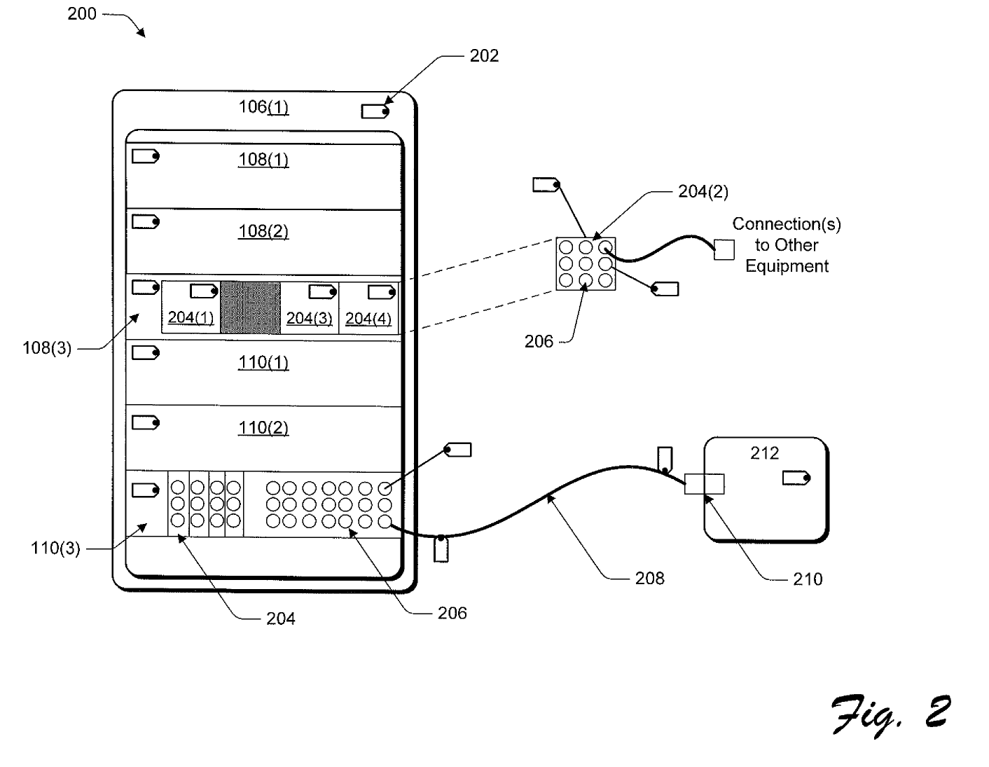

Network elements 110 may be implemented in a variety of ways. For example, network elements 110 may be configured as switches, digital cross connect system (DCS), telecommunication panels, terminal blocks, protector blocks, modules, digital radios, fiber optic equipment, network office terminating equipment, and any other telecommunication equipment or devices employed in a telecommunications infrastructure 102. It is noted that one or more of the components 108 within a cabinet 106 may also be a network element 110. In other words, network elements 110 may be found within a cabinet 106 as component 108 of the cabinet, or as a sub-component within another component 108. Thus, in a particular cabinet 106 interconnections may be between network elements 110 externally (e.g., not in the same cabinet) or internally (e.g., within the same cabinet). Naturally, internal and external interconnections may be mixed such that a single cabinet 106 will have both internal and external interconnections. Further, such connections for a particular cabinet 106 might be made wholly within a particular site 104. Interconnections may also be made between a plurality of sites 104. The variety of equipment depicted in FIG. 1 further may be provided with a plurality of RFID devices utilized to identify the equipment, store data regarding the equipment and/or provide access to data regarding the equipment and infrastructure 102, further discussion of which may be found in relation to FIGS. 2-8.

From the previous discussion, it should be appreciated that the equipment may be arranged in different generally hierarchal levels, e.g. equipment levels. For instance, infrastructure 102 has a plurality of sites 104, which has a plurality of cabinets 106, which hold a plurality of equipment and devices (components and network elements), which in turn may have various sub-components (modules, trays, connection points, cabling and interconnections), and so on. Thus, particular equipment may correspond to a particular equipment level in the hierarchy, e.g., the site level, the cabinet level, the component level and so on.

Radio Frequency Identification (REID) tags may be disposed on a variety of equipment throughout the infrastructure 102 at one or more of the various equipment levels. For instance, a cabinet 106 and a plurality of components 108 mounted within the cabinet may each be provided with respective RFID tags. A variety of other combinations of RFID tags arranged at different equipment levels are contemplated. The RFID tags provided with equipment at various equipment levels may be utilized to identify equipment and describe interrelations of equipment in infrastructure 102, further discussion of which may be found in relation to FIG. 2.

The environment 100 depicts a plurality of end users 112(1)-112(k), where “k” may be any integer from one to “K”. End users 112(1)-112(k) may be communicatively coupled, one to another, via a telecommunication network including infrastructure 102. End users 112 may be implemented in a wide variety of ways, such as consumers, business users, internal users in a private network, and other types of users that use telecommunications signals or transmit and receive telecommunications signals. Additionally, for purposes of the following discussion clients 112(1)-112(k) may also refer to client devices and software which are operable to transmit and receive telecommunications signals. Thus, clients 112(1)-112(k) may be implemented as users, software and devices.

The interconnection of pieces of equipment (e.g. cabinets 106, components 108 and network elements 110, and so forth) provides signal pathways between equipment for signals input to and output from infrastructure 102. For example, end-users 112(1)-112(k) may send signals into the infrastructure 102 and receive signals output from the infrastructure using a variety of end user devices 114. For example, end user 112(2) may communicate with end user 112(k) via end-user device 114 (e.g., a telephone). Thus, signals sent to and from infrastructure by end-users 112 via an end user device 114, may be routed directed, processed, and distributed in a variety of ways via the equipment and interconnections within infrastructure 102.

FIG. 2 illustrates an exemplary implementation 200 of one or more of the cabinets 106 of FIG. 1. The cabinet 106(1) in this instance is configured to hold a plurality of equipment. In particular, cabinet 106(1) is depicted as having has mounted within a plurality of components 108 and a plurality of network elements 110, which may be configured to provide various arrangements of signal pathways within the telecommunication infrastructure 102 of FIG. 1. Naturally the depicted implementation is one of a variety of contemplated equipment arrangements which may be used with the RFID devices and techniques described herein.

In an implementation, equipment (e.g. cabinets 106, components 108, network elements 110) may have one or more sub-components 204. For instance, component 108(3) in FIG. 2 is illustrated as having a plurality of sub-components 204(1)-204(4). Sub-components may be configured in a variety of ways, such as modules, trays, connectors, cabling, connector points, and terminations and so on. Further, any of the equipment, including the sub-components 204 may provide a plurality of connection points 206 to interconnect equipment in various ways thereby permitting many different arrangements of infrastructure 102. FIG. 2 for example depicts a variety of representative connection points 206 corresponding to network element 110(3) and sub-component 204(3). In this manner, a variety of different signal pathways are possible using the same equipment cabinet 106(1).

As previously described, a portion of infrastructure 102 of FIG. 1 may have a plurality of radio frequency identification (RFID) tags, such as the plurality of RFID Tags 202 depicted associated with equipment in FIG. 2. As shown in FIG. 2, The RFID tags 202 may be arranged at one or more equipment levels within infrastructure 102, such as at the cabinet level, component level, on sub-components, on cabling and so on. Although each level of equipment in FIG. 2 is depicted with associated RFID tags 202, in other implementations RFID tags 202 may be provided only at selected levels, or only with certain pieces of equipment in a particular level. For example, RFIDs 202 may be provided on cabinet 106(1) and on each sub-component 204 of components 108 within the cabinet without RFIDs on the components 108. A variety of other combinations of RFID tags arranged at different respective equipment levels is also contemplated.

Radio Frequency Identification (REID) is a technology for storing and remotely retrieving data using devices called RFID tags 202. An RFID tag 202 is an object that may be affixed or integrally formed to various equipment to identify the equipment and or to store information. In an implementation, an RFID tag 202 is integrally formed to a cabinet 106 or other equipment. Alternatively, RFID tags 202 may be fastened to the equipment. A variety of fastening mechanisms may be employed such as adhesive, fasteners, ties, rivets, screws, bolts, or other fastening mechanisms. Accordingly, equipment may be manufactured with RFID tags or retro fitted in existing applications

RFID tags may receive and respond to radio-frequency queries from an RFID reader. RFID Tags 202 may be configured in a variety of ways such as passive tags having no internal power source, powered active tags and so forth. A primary function of an RFID tag is to store a unique RFID. Each RFID tag has a unique RFID which may be used to identify a particular item, such as any piece of the telecommunication equipment to which the RFID is affixed. An RFID reader may be used to obtain the RFID from a piece of equipment. Further, RFID tags 202 may be read-only or may be read/write tags. The use of RFID tags provides a quick and convenient way to identify equipment and to store or access information about particular equipment.

FIG. 2 further depicts an interconnection via an exemplary cable 208. Cable 208 is illustrated having a pair of RFID tags 202. In an implementation, the RFID tags 202 are provided near each end of cable 208. Cable 208 is connected via a connection point 206 to network element 110(3) at one end. The other end depicts a connector 210 connecting the cable 208 to a piece of equipment 212. Thus, cable 208 interconnects network element 110(3) and equipment 212. Equipment 212 may be any of the previously described types of equipment in infrastructure 102, such as cabinets, components, network elements and so on. Equipment 212 may be arranged in the same cabinet 106(1) or another location (e.g site 104, cabinet 106 and so forth) with the infrastructure 102. The RFID tag 202 on a respective end of cable 208 may be configured to indicate where the other end of cable 208 is connected. For instance, RFID tag on cable 208 located closest to cabinet 106(1) may store data indicating that the other end is connected to equipment 212. Thus, a technician may access the RFID tag 202 on one end of cable 208 and understand the location of the other end.

In an implementation, RFID tags 202 may store infrastructure data in addition to the unique RFID. For example, RFID tags may be configured to store a variety of information regarding infrastructure 102 which may describe equipment and interconnections made within the infrastructure 102. For example, RFID tags 202 may be provided having infrastructure data which encompasses data describing the operations, installation and/or configuration of the cabinets 106, components 108, and network elements 110 and so on within infrastructure 102. One or more RFID tags may be utilized to store infrastructure data describing an entire cabinet 106(1) including all of the components 108, network elements 110 and interconnections thereof. Although an exemplary cabinet 106(1) representing a portion of infrastructure 102 is depicted in FIG. 2, it should be appreciated that RFID tags may also store infrastructure data for a larger or smaller portion of infrastructure 102. For example, a plurality of RFID tags 202 may be utilized with a variety of equipment at numerous sites 104 to identify equipment and store data throughout infrastructure 102.

In an implementation, the plurality of RFID tags 202 is utilized to understand the arrangement of equipment in infrastructure 102, e.g., how equipment is interrelated. As previously described, RFID tags may be disposed on a variety of equipment throughout the infrastructure 102 at one or more of the various equipment levels. FIG. 2 depicts RFID tags 202 disposed at cabinet level, component level, sub-component level and so on. RFID tags 202 may be configured in a variety of ways to describe equipment interrelations.

In an implementation, the interrelation of equipment is maintained on the equipment. An RFID tag 202 on a component 108(1), for example, may store data identifying the cabinet 106(1) in which the component 108(1) is mounted. In an implementation, the identifying data is the RFID of the cabinet 106(1), e.g. the unique identifier. In other words, the RFIDs of the two pieces of equipment are paired. The component 108(1) stores it own RFID and the REID of one or more interrelated piece of equipment, in this example the cabinet 106(1). Naturally, RFIDs may be paired at any of the previously described equipment levels and moving up or down between the hierarchal equipment levels. Thus, cable RFIDs tags may identify interrelated cabinets; cabinet RFIDs may identify sites, components, network elements and so forth; and component RFIDs may identify a site, a cabinet, a sub-component and so forth.

Optionally a systematic convention for pairing RFIDs may be employed. For instance, each piece of equipment having an RFID tag 202 may be configured to identify the piece of interrelated equipment at another equipment level. The other equipment level may be above or below the particular equipment level corresponding to the piece of equipment. In an example, each RFID tag is configured to identify a piece of interrelated equipment at the next highest level. Thus, if the equipment levels are site, cabinet, component, and sub-component then each sub-component identifies a component, each component identifies a cabinet and each cabinet identifies a site. In another example, RFID tags are provided on at least a cabinet 106 and a plurality of cables 208 connected to the cabinet 106. An RFID 202 on each cable 208 is configured to identify the cabinet 106 in which it is connected. A variety of other arrangements are contemplated in which a plurality of the RFID tags each stores its own respective REID and the RFID associated with at least one interrelated piece of equipment having a different respective equipment level.

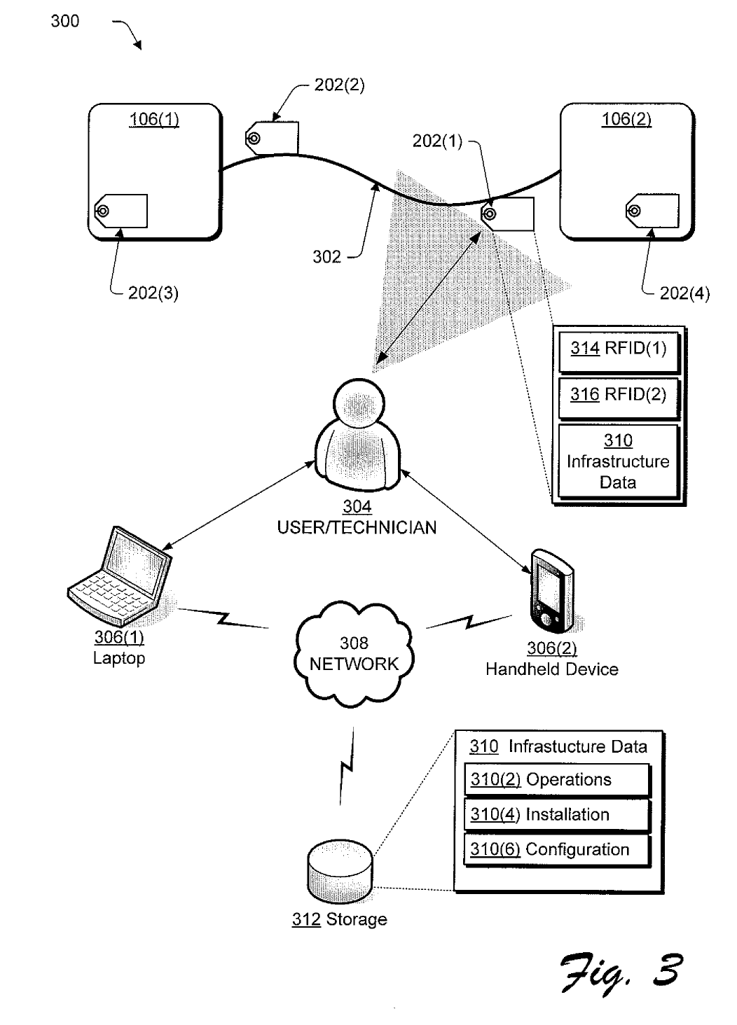

Alternatively, the RFID tag 202 may store data identifying its location within infrastructure 102 such as a Position ID, Cabinet ID, Site ID in lieu of or in addition to storing RFIDs of interrelated equipment. Naturally, RFID tag 202 on a component 108(1) may store data identifying other interrelations as well, such as interrelation to a plurality of sub-components 204, interconnections between equipment and so on. Thus, by reading a single RFID tag, information may be obtained for a plurality of equipment e.g. a portion of infrastructure 102, further discussion of which may be found in relation to FIGS. 3-5

Optionally, infrastructure data may be maintained in a database, in addition to or in lieu of storage on an RFID tag 202. The database may be maintained in local storage of a reader device, or may be accessible via a connection to a network from remote storage. In this instance, a RFID obtained from an RFID tag 202 may be used to obtain a variety of additional data about a corresponding piece of equipment. It is noted that a single RFID tag may maintain a plurality of RFIDs of corresponding equipment. The database may contain information previously obtained from RFID tags 202, data supplemental to information maintained on the RFID tags and combinations thereof. Thus, a RFID may be read from an REID tag 202 and used to access a variety of data regarding corresponding equipment.

FIG. 3 illustrates an exemplary implementation 300 depicting accessing the RFID tags 202 of FIG. 2. Cable 302 is depicted as making an interconnection between equipment in cabinet 106(1) of FIG. 2 and equipment in another cabinet 106(2). Cable 302 is depicted having a plurality of REID tags 202(1), 202(2) disposed on the cable 302. In an implementation, an REID tag 202 is disposed at each end of the cable. Naturally, a plurality of RFID tags 202 may also be used in both cabinets 106(1), 106(2), such as exemplary RFID tags 203(3), 202(4) depicted in FIG. 3.

A technician (e.g., user) 304 may use an external reader device 306 to access, read, and/or update REID tags 202. The reader device 306 may be a computing device such as a laptop 306(1), a handheld device 306(2), or other type of device configured to read data from and/or write data to RFID tags 202.

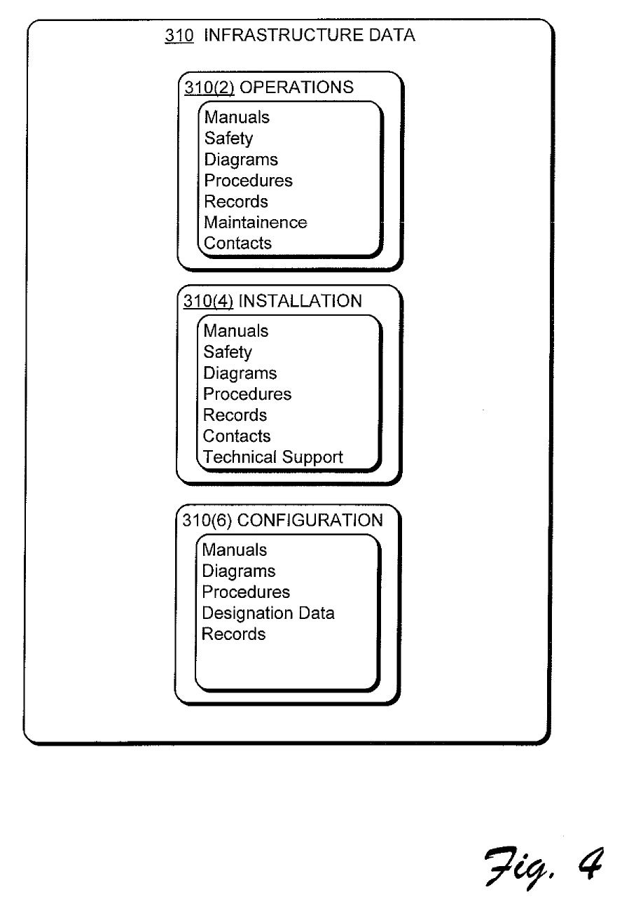

In an implementation, the reader device 306 is further configured to connect to a network 308 to access infrastructure data 310. The reader device 306 may be configured for wired connection, such as an Ethernet connection Alternatively, the reader device 306 may be configured for wireless connection, such as via Bluetooth, IEEE 802.11 (e.g., IEEE 802.11(b), 802.11(g), etc.), and so on. A variety of other implementations are also contemplated. Thus, a wired or wireless connection to network 308 provides access to infrastructure data 310 maintained remotely in storage 312. Infrastructure data 310 may be in lieu of or supplemental to data stored on RFID tags 202. As depicted in FIG. 3, infrastructure data 310 may include computer readable data describing one or more of the operation 310(2), installation 310(4) or configuration 310(6) of a portion of the infrastructure, further discussion of which may be found in relation to FIG. 4.

Further, a technician 302 may compile the data obtained from a plurality of RFID tags 202 in storage accessible via a reader device 306. For example, a technician 302 may access or update one or more REID devices 202 included within infrastructure 102. The infrastructure data for each RFID device 202 may be retrieved and copied to storage 312 located on the reader device or externally via network 308. Infrastructure data for all of infrastructure 102 or a portion thereof may similarly be compiled in one or more database.

FIG. 3 further depicts data stored on exemplary RFID tag 202(1) of cable 302. RFID tag 202(1) is depicted as storing its own RFID 314 and at least one other RFID 316. Storing a plurality of RFIDs on a single RFID tag provides a convenient way to identify interconnections and access information regarding infrastructure 102. A technician at a first location may obtain information for equipment in another location by reading RFID tags 202 available to the technician at the first location.

For example, FIG. 3 shows RFID 202(1) located on one end of cable 302 which is connected to cabinet 106(2). The other end of cable 302 is connected to cabinet 106(1). Cabinets 106(1) and 106(2) may be located apart from each other such as in different part of the same site 104, at different sites 104 and so forth. In an instance, RFID 316 is the RFID of the REID tag 202(3) depicted disposed within cabinet 106(1). Thus, technician 304 standing in close proximity to cabinet 106(2) may read tag 202(1) using reader device 306(1) and understand that the cable is connected within cabinet 106(1). RFID tag 202(1) is also depicted as storing infrastructure data 310. Thus, the technician reading tag 202(1) may be provided with additional information such as the type of cable, the type of connections, locations of equipment, and so on. Further, the RFIDs on RFID tag 202(1) may be used to access associated information from storage 312 as previously described.

In an implementation, RFID 316 corresponds to RFID tag 202(2) disposed on the other end of the cable. In this case, technician 304 may read RFID 202(1) to obtain an RFID associated with both ends of the wire. Having two RFID tags 202(1), 202(2) on the same wire permits unique data to be stored and/or associated with each end of a cable such as cable 302. At the same time, a technician may access additional data (e.g., from storage 312) associated with each RFID and accordingly with each end of the cable 302 by scanning a single RFID on one end of cable 302 to obtain both RFIDs. Further, technician may associate any common data with both RFID tags 202(1), 202(2) using the two RFIDs obtained from the single RFID tag.

In one implementation, the REID associated with tags 202(1), 202(2) disposed on each end of the cable is the identical RFID. Thus, the same information may be accessible by reading the RFID from the respective tag on either end of the cable 302. Additional RFID tags 202 with may be provided on the same cable 302 at intermediate locations which may or may not have identical RFIDs. Thus, data associated with a single cable 302 may be obtained using RFIDs at a plurality of locations in infrastructure 102. Tracing of a cable run, particularly a lengthy cable run, may be simplified by providing cables 302 having a plurality of RFID tags.

FIG. 4 illustrates infrastructure data 310 of FIG. 3 in greater detail. Infrastructure data 310 may include for example housing (e.g. cabinet) identifications, component identifications, network equipment identifications, user manuals, technical manuals, maintenance procedures, standard operating procedures, maintenance records, service records, operations records, part lists, technical support information, drawings, safety procedures, material safety data sheets, database files, spreadsheet files, word processor files, contact lists, telecommunications network configurations, designation data, and so on.

Operations data 310(2) may be a variety of data related to operation of equipment with infrastructure 102. For example, operations data 310(2) may include cabinet, component, or network element user manuals. Operations data 310(2) may also include diagrams, safety precautions and procedures, operating procedures, operating records, maintenance procedures, records, and contact lists.

Similarly installation data 310(4) may be a variety of data related to installation of equipment with infrastructure 102. For example, installation data 310(4) may include user manuals, safety precautions and procedures, installation diagrams, records, technical support information, and other data or files a technician might refer to when installing a cabinet, component, etc.

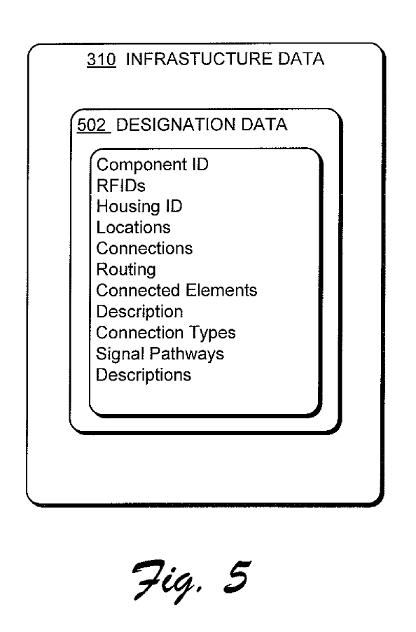

Configuration data 310(6) may be a variety of data related to configuration of equipment within infrastructure 102. For example, configuration data 310(6) may include configuration manuals, procedures, configuration diagrams, records, designation data, and other data or files related to configuration of equipment within infrastructure 102. As indicated configuration data 310(6) may include designation data further discussion which may be found in the following discussion of FIG. 5.

FIG. 5 depicts designation data 502 in more detail. Designation data may be a part of infrastructure data 306 or stand alone. Designation data describes the interconnections of equipment (e.g. components, cabinets, network elements) and signal pathways within a telecommunications network infrastructure. For example, designation data may be computer readable data which describes one or more of the routing of cables to make interconnections between components in the telecommunications infrastructure, the type of cables used, positions on equipment for interconnections, descriptions of signal pathways, and information about the components and network elements providing signal pathways. Designation data further may include a plurality of RFIDs from RFID tags disposed throughout infrastructure 102. RFID tags may be disposed on various interrelated equipment in a variety of equipment levels as previously described. Designation data for instance may describe which RFIDs correspond to which other RFIDs, the relative locations of associated equipment and accordingly described the interrelation of corresponding equipment. In this manner, designation data may be used to understand the positions, locations and interconnection of equipment throughout infrastructure 102. Further, an RFID tag may store various combinations of designation data. As depicted, designation data 502 may include one or more of component identifications, housing identifications, locations or positions within a cabinet or component, connections made at locations or positions, routing paths for wires, cabling etc within a site or portion of infrastructure, identification of connected elements, description of interconnections and components or network elements being interconnected connection types such as type of cabling or connectors, and descriptions or diagrams of signal pathways.

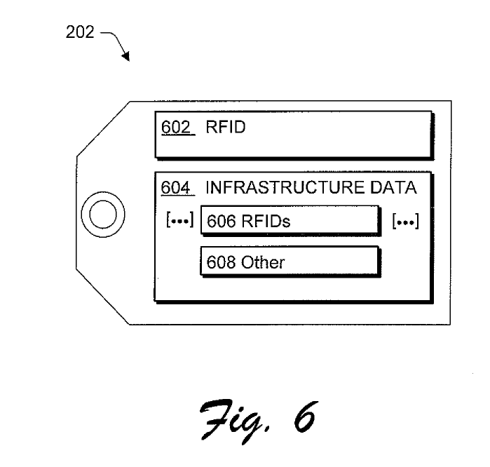

FIG. 6 depicts an exemplary implementation of a RFID tag 202 configured to store a unique RFID and additional infrastructure data. RFID tag 202 is depicted having a unique identifier RFID 602. The RFID tag may be affixed to various equipment as previously described. The RFID 602 may be read from RFID tag 202 to identify the particular equipment to which it is affixed. In addition, RFID tag 202 may store a variety of infrastructure data 604 describing equipment and interconnections thereof within telecommunications infrastructure 102.

In particular, the RFID tag 202 of FIG. 6 is configured to store a plurality of RFIDs 606. The plurality of RFIDs may be utilized to provide an indication of the interrelation of the particular piece of equipment to which the RFID tag 202 is attached to other equipment in infrastructure 102. For instance the plurality of RFIDs 606 may include RFIDs of equipment which is mounted to or within the particular piece of equipment to which RFID 202 is affixed. The plurality of RFIDs 606 may also include RFIDs of equipment where the particular piece of equipment is located. Further, RFID tag 202 may store RFIDs of equipment mounted in the same other piece of equipment. Thus, a single RFID tag 202 may store a plurality of RFIDs corresponding to different equipment. The RFIDs stored on single RFID tag may correspond to equipment having different respective equipment levels relative to each other. It is also contemplated that RFID 202 may store a variety of other infrastructure data 608 which may be configured in the manner previously described.

Exemplary Procedures

The following discussion describes techniques that may be implemented utilizing the previously described systems and devices. The procedures are shown as a set of blocks that specify operations performed by one or more devices and are not necessarily limited to the orders shown for performing the operations by the respective blocks.

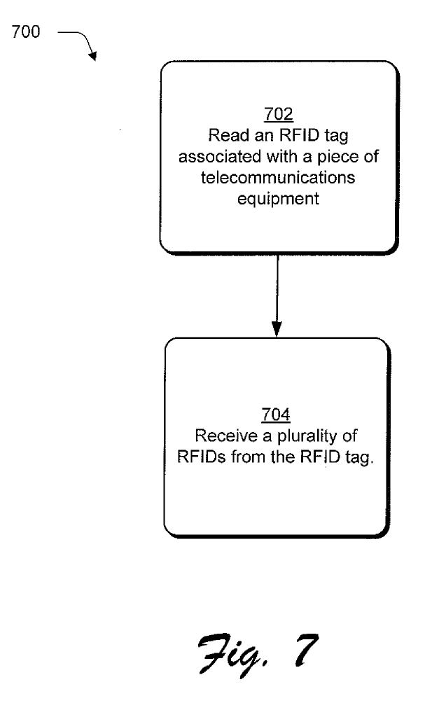

FIG. 7 is a flow diagram depicting a procedure 700 in an exemplary implementation in which an RFID tag of a piece of telecommunication equipment is read to identify the equipment and/or access data. An REID tag associated with a piece of telecommunication equipment is read (block 702). For instance, the RFID tag 202 associated with component 108(2) in FIG. 2 may be read, such as by a technician 304 using a reader 306 as depicted in FIG. 3.

A plurality of RFIDs are received from the RFID tag (block 704). In the previous instance, the technician 304 may receive the REID associated with the component 108(2) and the REID associated with cabinet 106(1). In other words, RFID tag 202 associated with component 108(2) stores both it own RFID and an RFID associated with the cabinet 106(1). Thus, technician accessing the RFID may understand the interrelation between component 108(2) and cabinet 106(2). The RFIDs may then be used to access additional information about the interrelation, infrastructure 102, and so forth as previously described.

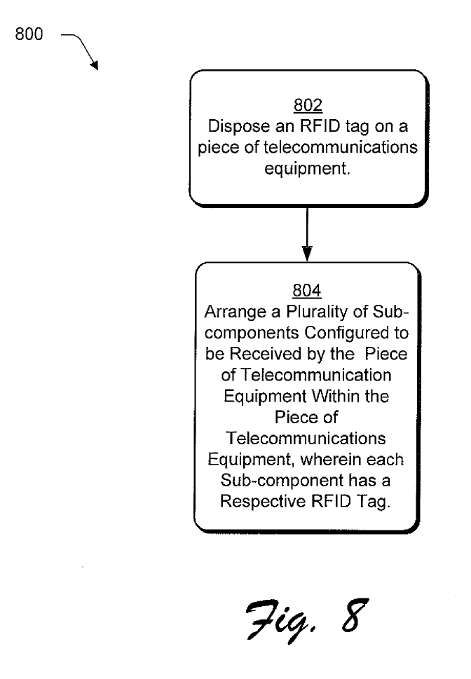

FIG. 8 is a flow diagram depicting a procedure 800 in an exemplary implementation in which telecommunications equipment having RFID tags is formed. An RFID device is disposed on a piece of telecommunications equipment (block 802). For instance, an RFID device 202 depicted in FIG. 2 may dispose on any of the illustrated equipment. For instance, device may be disposed on component 108(3) depicted in FIG. 2. FIG. 2 provides numerous other examples of pieces of equipment having RFID device 202 disposed thereon, such as cabinet 106(1), network element 110(1) and so forth.

A plurality of sub-components configured to be received by the piece of telecommunication equipment and having respective RFID tags are arranged within the piece of telecommunication equipment (block 804). In the case of component 108(3) of the previous example, FIG. 2 depicts a plurality of sub-components 204 arranged within component 108(3). Each sub-component 204 is further depicted having a respective RFID tag 202. The plurality of sub-components 204 may be configured the same or different from one another. FIG. 2 depicts a number of additional examples of equipment and sub-components of the equipment arranged with respective REID devices. For instance, components 108 are sub-components relative to cabinet 106(1). Thus, cabinet 106(1) is depicted with a RFID tag 202 and a plurality of sub-components (e.g., components 180) each having a respective RFID tag 202.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A telecommunication cable configured to interconnect two components comprising a radio frequency identification (RFID) tag disposed on one end and storing designation data describing the location of the other end of the cable within a telecommunications infrastructure.

2. The telecommunication cable described in claim 1 further comprising a second radio frequency identification (REID) tag disposed on said other end and storing designation data describing the location of said first end within the telecommunications infrastructure.

3. The telecommunication cable described in claim 2 wherein at least one said RFID tag stores designation data describing the location of both ends of the cable.

4. The telecommunication cable described in claim 1 wherein the designation data describes the unique identifier of a RFID tag associated with a telecommunication equipment housing in which the other end of the cable is terminated.

5. The telecommunication cable described in claim 1 wherein the designation data includes an identifier corresponding to a component to which the other end of the cable is connected.

6. The telecommunication cable described in claim 1, wherein the RFID tag is configured to store a type of cable.

7. The telecommunication cable described in claim 1, wherein the RFID tag is configured to store a type of cable connectors.

8. The telecommunication cable described in claim 1, wherein the location corresponds to a connection point within a telecommunication cabinet.

9. The telecommunication cable described in claim 8 wherein the connection point has an associated RFID tag and the designation data describes the RFID identifier associated with the connection point.

10. The telecommunication cable described in claim 1 wherein the RFID tag corresponds to infrastructure data accessible via a database.

11. The telecommunication cable described in claim 10 wherein the database describes an interrelation between a plurality of equipment within the telecommunication infrastructure.

12. A system comprising pieces of telecommunication equipment arrangable to provide a plurality of signal pathways within a telecommunications infrastructure, wherein:
each said piece of telecommunication equipment has a respective one of a plurality of RFID tags; and
a plurality of said telecommunications equipment is arranged within another of said telecommunications equipment.

13. The system described in claim 12 wherein each of the plurality of said telecommunication equipment is selected from the group consisting of:
a module;
a component;
a network element; and
a cable.

14. The system described in claim 12 wherein the other said equipment is a cabinet.

15. The system described in claim 12 wherein the other said telecommunications equipment is configured as a module insertable into one or more components to provide a plurality of connection points and at least one of the plurality of said telecommunications equipment is configured as a cable connectable to the module.

16. The system as recited in claim 12 wherein:
the plurality of said telecommunication equipment includes a cable, a module and a component; and
the cable is connected to a connecting point of the module and the module is inserted into the component.

17. The system as recited in claim 12 wherein the other said piece of equipment is a telecommunications equipment cabinet and the plurality of said telecommunications equipment includes a cable connected within the cabinet on at least one end.

18. A method comprising:
reading an RFID tag associated with a piece of telecommunication equipment; and
receiving a plurality of RFIDs from the RFID tag.

19. The method as recited in claim 18 further comprising, obtaining infrastructure data corresponding to the piece of telecommunication equipment

20. The method as recited in claim 19 wherein the infrastructure data is obtained from the RFID tag.

21. The method as recited in claim 19 wherein the infrastructure data is stored in a database accessible to a reading device performing the reading.

22. The method as recited in claim 19 wherein the infrastructure data is stored in storage on a reading device performing the reading.

23. The method as recited in claim 19 wherein the infrastructure data describes an interrelation between the piece of telecommunication equipment and at least one other piece of telecommunication equipment.

24. A method comprising:
disposing an RFID tag on a piece of telecommunications equipment; and
arranging a plurality of sub-components configured to be received by the piece of telecommunication equipment within the piece of telecommunications equipment, wherein each sub-component has a respective RFID tag.

25. The method described in claim 24 further comprising storing an RFID corresponding to the piece of telecommunications equipment on the respective RFID tag of at least one said sub-component.

26. The method recited in claim 24 wherein the telecommunication equipment is configured as a cabinet.

27. The method recited in claim 24 further comprising arranging at least one other sub-component within one said sub-component of the plurality of sub-components, wherein each other sub-component has a respective RFID tag.
